(19) United States
(12) Patent Application Publication
(10) Pub. No.: US 2004/0124054 A1
(43) Pub. Date: Jul. 1, 2004

(54) Handle control structure for luggage

(76) Inventor: Lien Ching Lu, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,464

(22) Filed: Dec. 31, 2002

(51) Int. Cl. A45C 13/30; A45C 13/00; A47J 45/00; B65D 25/28

(52) U.S. Cl. 190/115; 16/113.1

(57) ABSTRACT

An improved handle control structure for luggage and particularly a handle structure for controlling the extension and retraction of the pulling bar of a luggage mainly includes a handle section, a control section, an adjusting section and a coupling section. The handle section has a bucking member running through a control slot of a coupling member of the control section. The bucking member has a concave section pressing the top end of a push rod. The push rod has a ram head pressing a sloped angle of a sliding member of the adjusting section for controlling the movement of a left and a right push bar of the coupling section, thereby the control bar in the extensible tube may be controlled and moved upwards or downwards, and the extensible tube may also be extended as desired.

### BACKGROUND OF THE INVENTION

1. Field of the Invention

The invention relates to an improved handle control structure for luggage and particularly a handle structure for controlling the extension and retraction of the pulling bars of the luggage.

2. Description of the Prior Art

The handle of conventional luggage generally is movable in only one direction (i.e. parallel with the luggage) and cannot be moved in other directions. Moreover, the handle of the luggage provides merely extension or retraction movement. Such a stereotyped design cannot fully satisfy the versatile and multifunctional requirements of consumers these days. There is a growing demand to develop and introduce innovative luggage handles to differentiate from the conventional ones, and to meet the different requirements of consumers and to gain competitive edge on the market.

### SUMMARY OF THE INVENTION

Therefore the primary object of the invention is to provide an improved handle structure for luggage that can effectively control the extension and retraction of the luggage handle.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 2A is a perspective view of the upper shell of the invention.

FIG. 3 is a sectional view of the invention showing the handle section, control section and adjusting section in a position before depressed.

FIG. 4 is a sectional view of the invention showing the adjusting section, coupling section and extensible tube in a position before depressed.

FIG. 5 is a sectional view of the invention showing the handle section, control section and adjusting section in a position after depressed.

FIG. 6 is a sectional view of the invention showing the adjusting section, coupling section and extensible tube in a position after depressed.

### DESCRIPTION OF THE PREFERRED EMBODIMENT

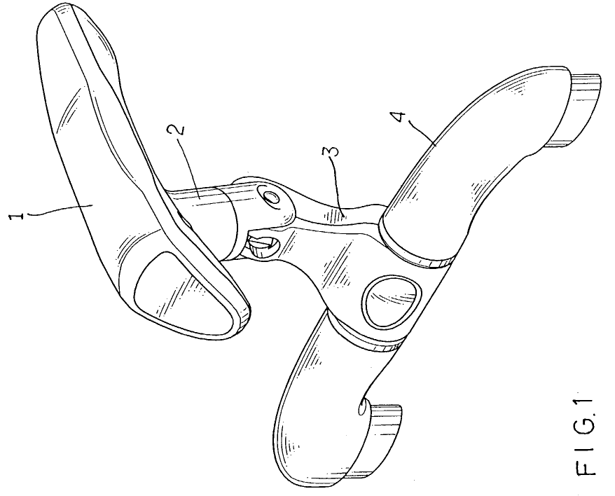

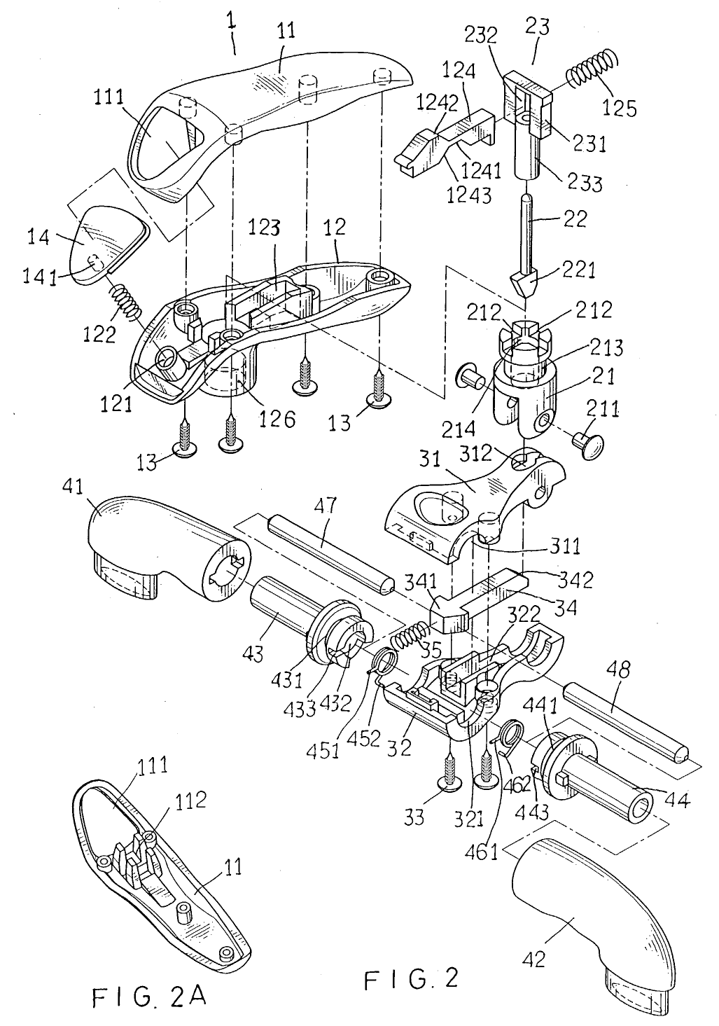

Referring to FIGS. 1, 2 and 2A, the invention mainly includes a handle section 1, a control section 2, an adjusting section 3 and a coupling section 4.

The handle section 1 includes an upper shell 11 and a lower shell 12 fastening together by means of screws 13. The upper shell 11 has an opening 111 located on one end thereof for housing a pushbutton 14. The lower shell 12 has a housing compartment 121 corresponding to the opening 111 of the upper shell 11 for holding a spring 122. The spring 122 has another end coupling with a strut 141 of the pushbutton 14. In addition, the upper shell 11 and the lower shell 12 have respectively a retaining trough 112 and 123 for holding a bucking member 124 and a spring 125. And the lower shell 12 has a cavity 126 formed on a lower side to engage with the control section 2. The bucking member 124 has a concave section 1241 to press the top end of a push rod 22 of the control section 2, and an upper sloped angle 1242 and a lower sloped angle 1243.

The control section 2 has a connecting member 21 which has a lower end pivotally engaged with the adjusting section 3 by means of a rivet 211 and an upper end forming a coupling trough 212. The connecting member 21 has a neck 213 formed by plastic injection for housing in the cavity 126. The connecting member 21 has a hole 214 formed in the center to enable the push rod 22 to run through from the lower end to the upper end thereof. The push rod 22 has another end running through a coupling member 23. The coupling member 23 has an upper side forming a retaining block 231 for wedging in the coupling trough 212 of the connecting member 21. In the retaining block 231, there is a control slot 232 to receive the bucking member 124.

The adjusting section 3 includes an upper casing 31 and a lower casing 32 fastening together by means of screws 33. One end of the upper and lower casings 31 and 32 has a coupling groove 311 and 321 corresponding to each other for coupling the coupling section 4. The lower casing 32 has a housing chamber 322 for holding and retaining a sliding member 34. The sliding member 34 has one end forming a bucking head 341. A spring 35 is provided to push the bucking head 341 to its original position. The sliding member 34 has another end apart from the bucking head 341 to form a sloped angle 342 which is in contact with a ram head 221 of the push rod 22. The upper casing 31 further has an anchor hole 312.

The coupling section 4 includes a left coupling duct 41 and a right coupling duct 42 that have a bottom end connecting to an extensible tube 5 of the pulling bar. The left coupling duct 41 and the right coupling duct 42 house respectively therein a hollow left rod 43 and a right rod 44. The hollow left rod 43 and the right rod 44 have one end inserting into the left coupling duct 41 and the right coupling duct 42, and have keys and key ways to couple with each other for positioning. The hollow left rod 43 and the right rod 44 further house there in a left push bar 47 and a right push bar 48. The left rod 43 and the right rod 44 have respectively a coupling neck 431 and 441 to couple with the coupling groove 311 and 321 of the adjusting section 3, and a recess 432 and 442 for holding a torsional spring 45 and 46. The torsional springs 45 and 46 have one foot 451 and 461 wedged in a notch 433 and 443 of the recesses 432 and 442, and another foot 452 and 462 wedged in the lower casing 32 of the adjusting section 3.

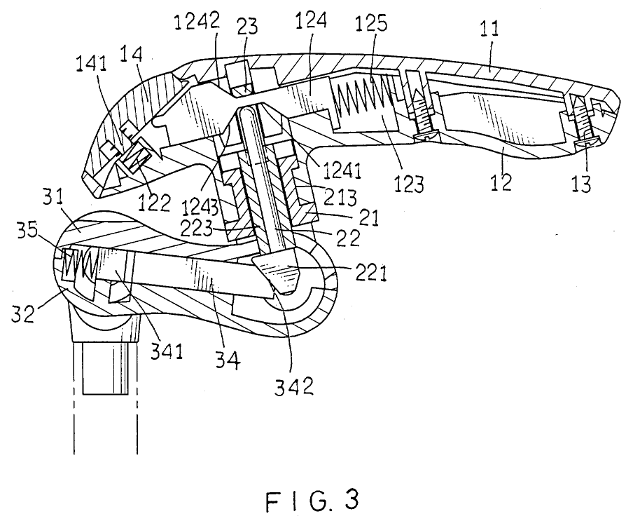

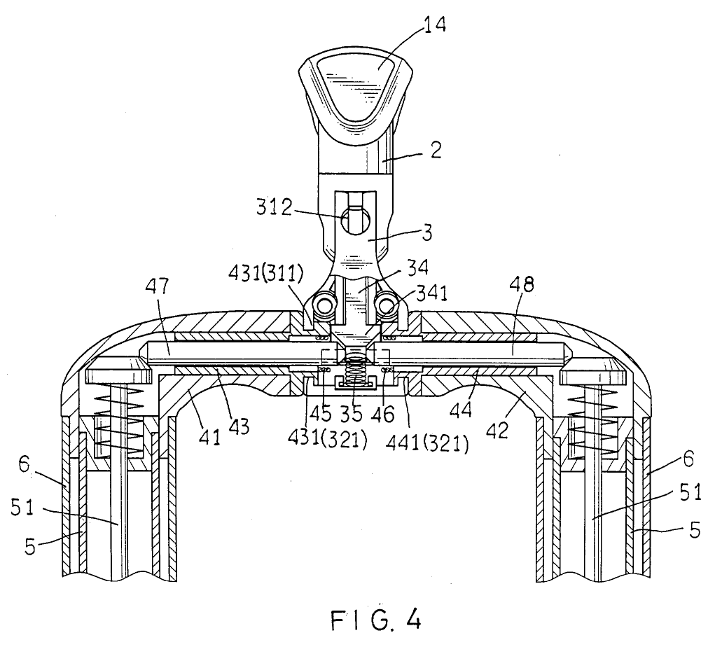

Refer to FIG. 3 for the invention before being depressed. The bucking member 124 of the handle section 1 runs through the control slot 232 of the coupling member 23. The concave section 1241 presses the top end of the push rod 22. The ram head 221 of the push rod 22 is in contact with the sloped angle 342 of the sliding member 34. The bucking head 341 of the sliding member 34 controls the left and right push bars 47 and 48 of the control section 4. And the left and right push bars 47 and 48 are in contact with a control bar 51 of the extensible tube 5 (as shown in FIG. 4).

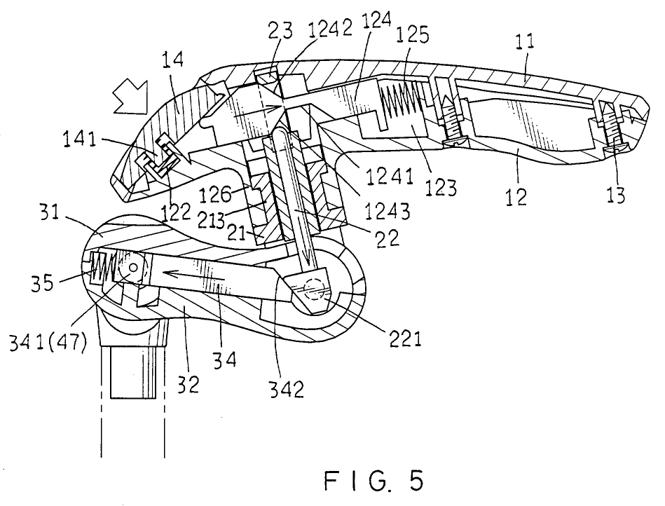

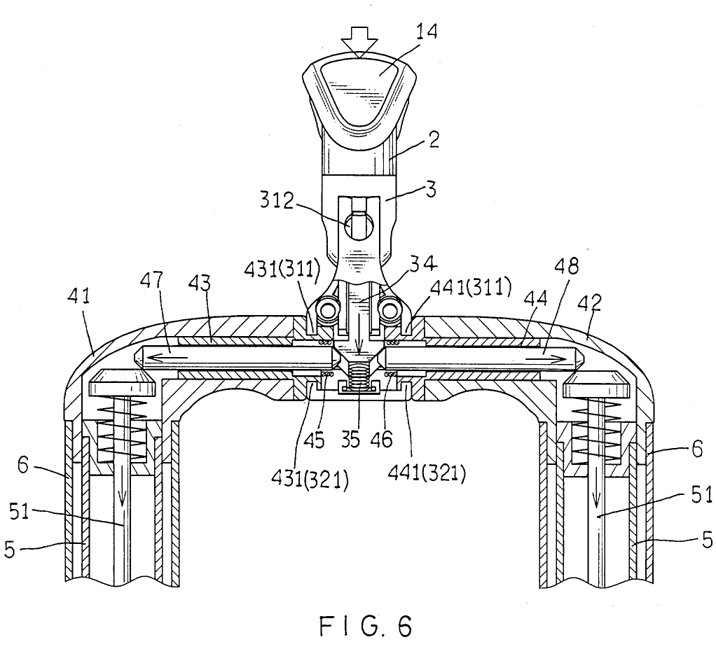

Referring to FIG. 5, when in use for extending the extensible tube 5, first, depress the pushbutton 14 of the handle section 1, the pushbutton 14 drives the bucking member 124 forwards, and the lower sloped angle 1243 depresses the push rod 22 downwards, consequently the ram head 221 of the push rod 22 pushes the sliding member 34 forwards which in turn pushes the left and right push bars 47 and 48, and the control bar 51 in the extensible tube 5 also is moved downwards (as shown in FIG. 6). As a result, the control bar 51 may control a control valve (not shown in the drawings) to escape an outer tube 6, and the extensible tube 5 may be pulled upwards (the structure of the control valve to escape the outer tube 6 in the luggage is known in the art, thus details are omitted). When the extensible tube 5 reaches a desired position, the sliding member 34 and the bucking member 124 return to their original positions through the elastic forces of the springs 35 and 125.

Thus when an user wants to adjust the height of the handle, he/she merely depresses the pushbutton 14, the bucking member 124 pushes the push rod 22 which in turn moves the sliding member 34 and the left and right push rods 47 and 48 to actuate the control bar 51, therefore the extensible tube 5 may be moved upwards or downwards.

By means of the aforesaid construction the handle of the luggage may be moved and adjusted to a desired height easily. It is a novel design different from the stereotyped design of the conventional luggage now on the market.

While the preferred embodiment of the invention has been set forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

I claim:

1. An improved handle structure for a luggage comprising a handle section, a control section, an adjusting section and a coupling section, wherein:
the handle section includes an upper shell and a lower shell fastening together by means of screws, the upper shell having an opening located on one end thereof for housing a pushbutton, the lower shell having a housing compartment corresponding to the opening of the upper shell for holding a first spring, the first spring having another end coupling with a strut of the pushbutton, the upper shell and the lower shell having respectively a retaining trough for holding a bucking member and a second spring, the lower shell having a cavity formed on a lower side thereof to engage with the control section;
the control section has a connecting member which has a lower end pivotally engaged with the adjusting section by means of a rivet and an upper end forming a coupling trough, the connecting member also having a neck formed by plastic injection for housing in the cavity in a pivotal manner, the connecting member having a hole in the center thereof to allow a push rod to run through from a lower end to an upper end thereof, the push rod having another end running through a coupling member, the coupling member having an upper side forming a retaining block for wedging in the coupling trough of the connecting member, the retaining block having a control slot to receive the bucking member;
the adjusting section includes an upper casing and a lower casing fastening together by means of screws, the upper and the lower casings having respectively one end to form a corresponding coupling groove for coupling the coupling section, the lower casing having a housing chamber for holding and retaining a sliding member, the sliding member having one end forming a bucking head which is pressed by a second spring to its original position, the sliding member having one end apart from the bucking head to form a sloped angle in contact with a ram head of the push rod, the upper casing further having an anchor hole; and
the coupling section includes a left coupling duct and a right coupling duct that have a bottom end connecting to an extensible tube of a pulling bar, the left coupling duct and the right coupling duct housing respectively therein a hollow left rod and a right rod, the hollow left rod and the right rod having respectively a coupling neck to couple the coupling groove of the adjusting section.

2. The improved handle structure for a luggage of claim 1, wherein the connecting member has a coupling trough forming on an upper end thereof and the neck is formed by plastic injection for housing in the cavity in a pivotal manner.

3. The improved handle structure for a luggage of claim 1, wherein the left rod and the right rod left are coupled with the left coupling duct and the right coupling duct by means of keys and key ways formed thereon.
